(19) United States
(12) Patent Application Publication
(10) Pub. No.: US 2025/0313260 A1
(43) Pub. Date: Oct. 9, 2025

(54) STEERING FEEDBACK ACTUATOR AND STEER-BY-WIRE STEERING APPARATUS WITH THE SAME

(71) Applicant: HL MANDO CORPORATION, Pyeongtaek-si (KR)

(72) Inventor: TaeHo KIM, Pyeongtaek-si (KR)

(73) Assignee: HL MANDO CORPORATION, Pyeongtaek-si (KR)

(21) Appl. No.: 19/078,005

(22) Filed: Mar. 12, 2025

(30) Foreign Application Priority Data
Apr. 8, 2024 (KR) 10 2024 0047270

(51) Int. Cl. B62D 5/00; B62D 5/04; B62D 15/02

(52) U.S. Cl. CPC B62D 5/006; B62D 5/0409; B62D 5/0421; B62D 5/043; B62D 15/0215

(57) ABSTRACT

The present embodiments provide a steering feedback actuator including a housing to which a steering shaft is rotatably coupled, a reaction motor coupled to the housing and connected to the steering shaft to provide a steering reaction force, a rotor coupled to the steering shaft, and a clutch unit including a stopper fixed to the housing, and optionally restraining the rotor to the stopper.

### CROSS REFERENCE TO RELATED APPLICATION

This application claims priority from Korean Patent Application No. 10-2024-0047270, filed on Apr. 8, 2024, which is hereby incorporated by reference for all purposes as if fully set forth herein.

### TECHNICAL FIELD

Embodiments of the present disclosure are related to a steering feedback actuator and a steer-by-wire steering apparatus including the same, more specifically, related to a steering feedback actuator and a steer-by-wire steering apparatus including the same capable of efficiently designing motor output and electrical component size by separating a structure providing steering reaction force and a structure limiting a steering angle.

### BACKGROUND

A steer-by-wire steering device is a type of electric steering device that steers a vehicle using electrical power without a mechanical connection such as an intermediate shaft or universal joint between a steering wheel and a front wheel steering device.

That is, the driver's steering wheel operation is converted into an electric signal, which is input to an electronic control device, and the motor output is determined accordingly. Since the steer-by-wire steering system has no mechanical connection, it is possible to reduce the driver's injury due to the mechanism in the event of a collision, and since the number of mechanical connections and hydraulic components can be reduced, the number of parts may be reduced, which simplifies the vehicle's weight and line assembly work, thereby reducing unnecessary energy consumption during steering operation and improving fuel efficiency. In addition, ideal steering performance may be achieved through ECU programming.

Since the steer-by-wire steering device has no mechanical connection between the steering shaft and the wheels, in order for the driver to feel a steering feel similar to that of a conventional steering system, it is required to generate an appropriate steering reaction force in the steering wheel when performing the steering operation.

In addition, if the steering wheel reaches the maximum steering angle, or if the front wheel rotation is no longer possible due to the mechanical structure of the road wheel actuator (RWA) that steers the front wheel or an obstacle on the road surface, it is required to limit the driver from turning the steering wheel any further.

In general, the driver's steering wheel rotation may be restricted by using a motor to provide steering reaction force to the driver. However, this structure requires a motor with high output to respond to the driver's steering torque, which increases the cost and increases the size of the electrical components.

### BRIEF SUMMARY

Embodiments of the present disclosure relate to a steering feedback actuator and a steer-by-wire steering apparatus with the same, which can efficiently design motor output and electrical component size by separating a structure providing steering reaction force and a structure limiting a steering angle.

In accordance with embodiments of the present disclosure, there may be provided a steering feedback actuator including a housing to which a steering shaft is rotatably coupled, a reaction motor coupled to the housing and connected to the steering shaft to provide a steering reaction force, a rotor coupled to the steering shaft, and a clutch unit including a stopper fixed to the housing, and optionally restraining the rotor to the stopper.

In addition, in accordance with embodiments of the present disclosure, there may be provided a steer-by-wire steering apparatus including a steering feedback actuator including a housing to which a steering shaft is rotatably coupled, a reaction motor coupled to the housing and connected to the steering shaft to provide a steering reaction force, a rotor coupled to the steering shaft, and a clutch unit including a stopper fixed to the housing and optionally restraining the rotor to the stopper, and a road wheel actuator that steers a wheel according to a rotation angle of the steering shaft.

According to embodiments of the present disclosure, it if possible to efficiently design the motor output and electrical component size by separating the structure for providing the steering reaction force and the structure for limiting the steering angle.

### BRIEF DESCRIPTION OF THE SEVERAL VIEWS OF THE DRAWINGS

FIG. 1 is a configuration diagram of a steer-by-wire steering apparatus according to the present embodiments.

FIG. 2 is an exploded perspective view of a steering feedback actuator according to the present embodiments.

FIG. 3 is a front view of a part of a steering feedback actuator according to the present embodiments.

FIG. 4 is an exploded perspective view of a part of a steering feedback actuator according to the present embodiments.

FIG. 5 is a cross-sectional view of a part of a steering feedback actuator according to the present embodiments.

FIG. 6 and FIG. 7 are cross-sectional views of a part of a steering feedback actuator according to the present embodiments.

FIG. 8 is an exploded perspective view of a part of a steering feedback actuator according to the present embodiments.

FIG. 9 is an exploded perspective view of a part of a steering feedback actuator according to the present embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

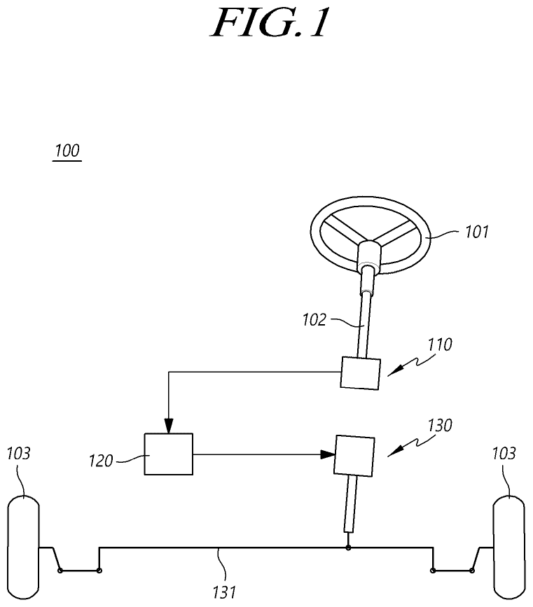

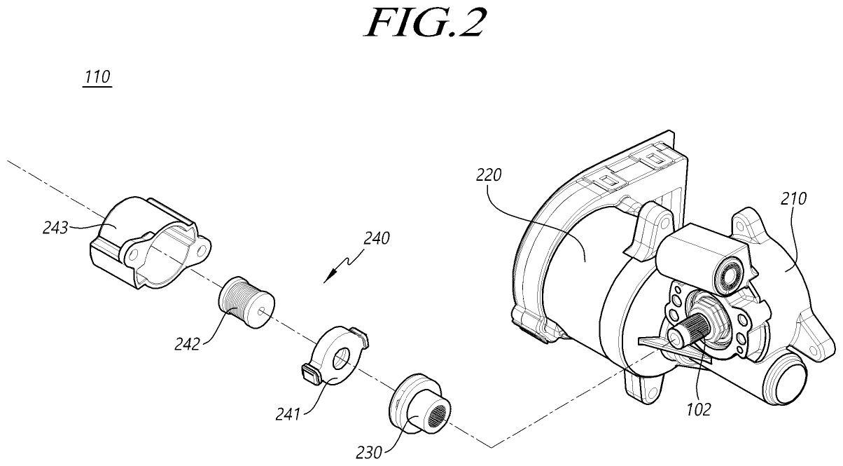

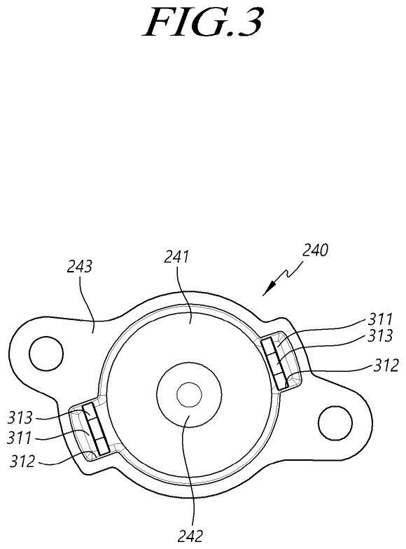

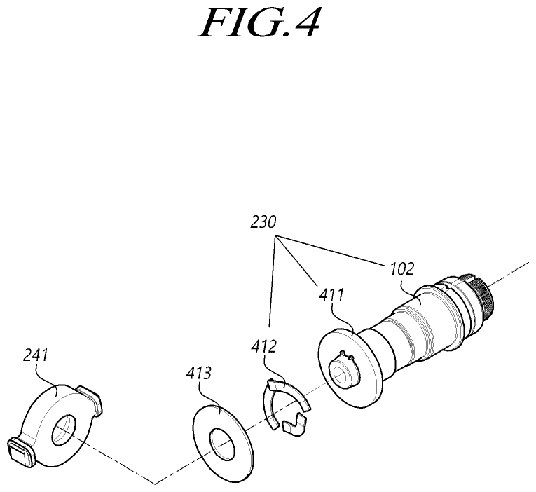

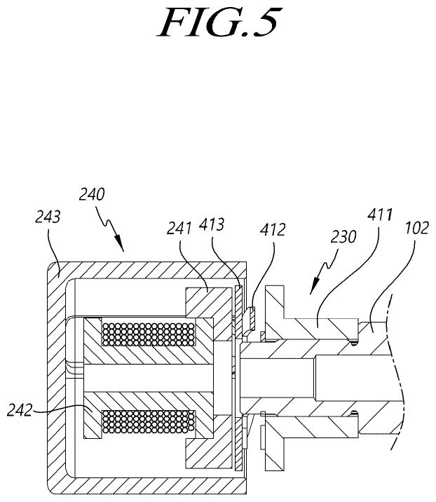

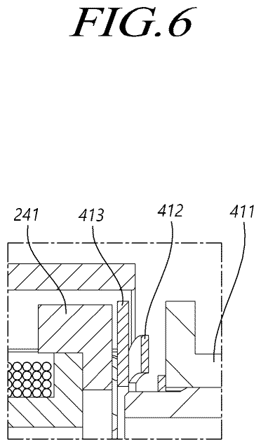

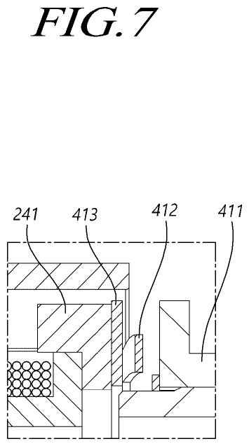

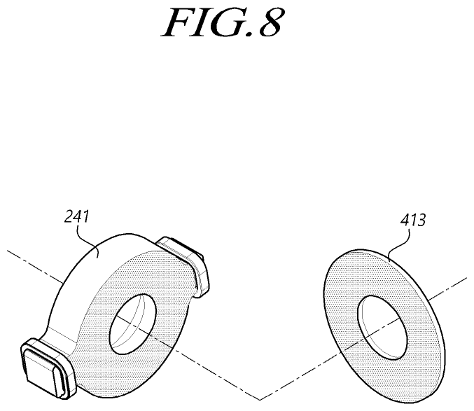

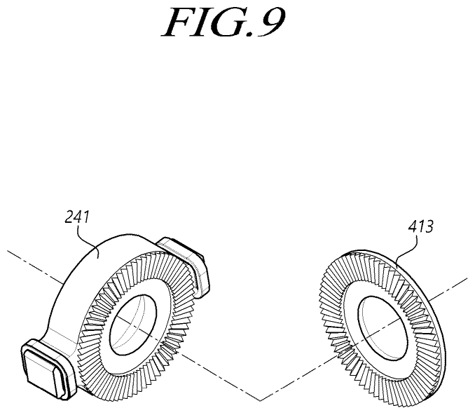

FIG. 1 is a configuration diagram of a steer-by-wire steering apparatus according to the present embodiments, FIG. 2 is an exploded perspective view of a steering feedback actuator according to the present embodiments, FIG. 3 is a front view of a part of a steering feedback actuator according to the present embodiments, FIG. 4 is an exploded perspective view of a part of a steering feedback actuator according to the present embodiments, FIG. 5 is a cross-sectional view of a part of a steering feedback actuator according to the present embodiments, FIG. 6 and FIG. 7 are cross-sectional views of a part of a steering feedback actuator according to the present embodiments, FIG. 8 is an exploded perspective view of a part of a steering feedback actuator according to the present embodiments, and FIG. 9 is an exploded perspective view of a part of a steering feedback actuator according to the present embodiments.

The present embodiments may provide a steering feedback actuator 110 including a housing 210 to which a steering shaft 102 is rotatably coupled, a reaction motor 220 coupled to the housing 210 and connected to the steering shaft 102 to provide a steering reaction force, a rotor 230 coupled to the steering shaft 102, and a clutch unit 240 including a stopper 241 fixed to the housing 210, and optionally restraining the rotor 230 to the stopper 241.

In addition, according to the present embodiments, it is possible to provide a steer-by-wire steering apparatus 100 including a steering feedback actuator 110 according to the present embodiments and a road wheel actuator that steers a wheel according to the rotation angle of a steering shaft.

Referring to FIG. 1, the steer-by-wire steering apparatus 100 according to the present embodiments includes a steering feedback actuator 110, a road wheel actuator 130, and a controller 120 according to the present embodiments. The road wheel actuator 130 includes a sliding bar 131 connected to a wheel at both ends, and steers the wheel by sliding the sliding bar 131 according to the rotation angle of the steering shaft. Since the detailed structure of the road wheel actuator 130 may correspond to a general configuration, a detailed description thereof will be omitted.

The steering feedback actuator 110 according to the present embodiments generates a steering reaction force on the steering shaft 102 to improve the steering feel of the driver steering the steering wheel 101, and also restricts the driver's steering wheel operation under specific conditions such as the maximum steering angle, as will be described in detail later.

In general, the output of the reaction motor providing the steering reaction force may be increased to restrict the driver's steering wheel operation under specific conditions. However, the motor output for restricting the steering wheel operation may be much higher than the motor output for providing the steering reaction force, so that the conventional structure has an inefficient problem of requiring a high-output reaction motor and thus increasing the motor size.

Meanwhile, the steering feedback actuator 110 according to the present embodiments and the steer-by-wire steering apparatus 100 including the same have the advantage of being able to efficiently design the output of the reaction motor and the size of the entire components by separating the structure providing the steering reaction force and the structure limiting the steering angle.

Firstly, in the steer-by-wire steering apparatus 100 as described in the present embodiments, the method of limiting the steering angle through the control of the controller 120 will be explained.

The controller 120 may control the clutch unit 240 of the steering feedback actuator 110 according to the present embodiments to limit the steering angle. As described in detail later, when the rotor 230 is restrained to the stopper 241 through the operation of the clutch unit 240, the steering shaft 102 can no longer rotate and the steering angle is limited.

The limitation of the steering angle by the controller 120 can be performed in various situations, such as a case in which the rotation angle of the steering wheel 101 described later reaches the maximum rotation angle, a case in which the stroke of the sliding bar 131 reaches the maximum stroke, and a case in which the wheel gets caught on an obstacle.

According to one embodiment, the steering feedback actuator 110 according to the present embodiments further includes a steering angle sensor (not shown) that detects the rotation angle of the steering shaft 102.

The controller 120 may control the clutch unit 240 so that the rotor 230 is restrained by the stopper 241 when the steering angle received from the steering angle sensor reaches the preset maximum steering angle.

According to one embodiment, the road wheel actuator 130 may further include a sliding bar 131 that is connected to the wheel 103 at both ends and slides according to the rotation angle of the steering shaft 102, and a stroke sensor (not shown) for detecting the stroke of the sliding bar 131.

The controller 120 may control the clutch unit 240 so that the rotor 230 is restrained by the stopper 241 when the stroke received from the stroke sensor reaches a preset maximum stroke.

In this way, the steer-by-wire steering apparatus 100 according to the present embodiments may include an appropriate sensor, and may control the clutch unit 240 to limit the steering angle in response to an occurrence of a situation in which the rotation of the steering shaft 102 is required to be limited.

That is, the steering angle can be limited without using a reaction motor that generates the steering reaction force, and thus the motor output and the size of the electrical components can be designed efficiently.

Hereinafter, the steering feedback actuator 110 according to the present embodiments will be described with reference to FIGS. 2 to 8.

Referring to FIG. 2, the steering feedback actuator 110 according to the present embodiments includes a housing 210, a reaction motor 220, a rotor 230, and a clutch unit 240. The steering shaft 102 is rotatably coupled to the housing 210.

The housing 210 may be coupled to a steering column (not shown) that accommodates the steering shaft 102. The detailed structure of the steering column is generally known, so a detailed description thereof is omitted.

The reaction motor 220 is coupled to the housing 210 and is connected to the steering shaft 102 to provide steering reaction force to the steering shaft 102. That is, in a general driving situation where the steering angle is not limited, the reaction motor 220 generates an appropriate steering reaction force to the steering shaft 102 and improves the driver's steering feel.

According to one embodiment, the steering feedback actuator 110 according to the present embodiments may further include a reducer connecting the reaction motor 220 and the steering shaft 102.

According to one embodiment, the reducer may include a worm shaft coupled to a motor shaft of the reaction motor 220, and a worm wheel meshed with the worm shaft and coupled to the steering shaft.

The rotor 230 is coupled to the steering shaft 102 and rotates together with the steering shaft 102.

The clutch unit 240 includes a stopper 241 fixed to the housing 210, and optionally restrains the rotor 230 to the stopper 241. The stopper 241 may be fixed to the housing 210 and may not rotate.

The rotor 230 coupled to the steering shaft 102 is restrained by the fixed stopper 241, thereby restricting the rotation of the steering shaft 102. That is, by the operation of the clutch unit 240, the rotor 230 is restrained by the stopper 241 in a state of rotating together with the steering shaft 102, thereby restricting the rotation of the steering shaft 102.

Referring to FIGS. 2 and 3, the structure of the clutch unit 240 is described. According to one embodiment, the clutch unit 240 may further include a case 243 coupled to the housing 210. The steering shaft 102 is provided such that an end protrudes from the housing 210, and the case 243 accommodates the protruding end of the steering shaft 102 and is coupled to the housing 210.

According to one embodiment, the stopper 241 may be rotatably supported and coupled to the case 243.

The stopper 241 is provided on the inside of the case 243 and is fixed to the housing 210 by being rotatably supported. Accordingly, the rotor 230 is restrained by the stopper 241 and the rotation of the steering shaft 102 is also restricted.

According to one embodiment, the stopper 241 may have at least one support portion 311 formed radially protruding, and the case 243 may have a recessed groove 312 formed into which the support portion 311 is inserted. The support portion 311 is inserted into the recessed groove 312, and the stopper 241 is rotatably supported by the case 243.

The drawings of the present embodiments illustrate an embodiment in which two support portions 311 are provided on the stopper 241, and accordingly, two recessed grooves 312 are formed on the case 243.

According to one embodiment, the clutch unit 240 may further include a damping member 313 coupled to the support portion 311 and positioned between the support portion 311 and the recessed groove 312.

As illustrated in the drawings, the damping member 313 may be provided in a ring shape that surrounds the outer surface of the support portion 311. The damping member 313 is provided between the support portion 311 and the recessed groove 312, and provides damping function in both rotational directions.

Therefore, the shock generated when the clutch unit 240 is operated and the rotation of the steering shaft 102 is restricted may be cushioned, thereby minimizing the uncomfortable feeling received by the driver. The damping member 313 may be formed of, for example, rubber, and the hardness or thickness of the damping member 313 may be adjusted to implement an appropriate damping force.

Referring to FIGS. 4 and 5, the rotor 230 may include a fixed member 411 fixed to the steering shaft 102, and a moving member 413 connected to the fixed member 411 and selectively restrained to the stopper 241 by the clutch unit 240.

The fixed member 411 is fixed to the steering shaft 102 in both the axial direction and the rotational direction. As shown in the drawing, the fixed member 411 may be fixed to the steering shaft 102 in the axial direction by a snap ring.

In addition, the fixed member 411 may be fixed to the steering shaft 102 in the rotational direction by engaging with a spline. The moving member 413 is provided to be fixed to the fixed member 411 in the rotational direction, but movable in the axial direction.

The moving member 413 may be moved in the axial direction by the clutch unit 240, and may be selectively contacted and restrained by the stopper 241, or may be separated and released from the stopper 241.

That is, according to one embodiment, the stopper 241 is provided coaxially with the steering shaft 102 and opposite the moving member 413, and the moving member 413 may be separated from the stopper 241 or contacted and restrained to the stopper 241 by the clutch unit 240.

If the moving member 413 is separated from the stopper 241, the rotation of the steering shaft 102 is not obstructed, and if the moving member 413 is in contact with and restrained by the stopper 241, the rotation of the steering shaft 102 is restricted.

FIG. 6 illustrates a situation in which the moving member 413 is separated from the stopper 241 and the rotation of the steering shaft 102 is not restricted, and FIG. 7 illustrates a situation in which the moving member 413 is contacted and restrained by the stopper 241 and the rotation of the steering shaft 102 is restricted.

By the operation of the clutch unit 240, the moving member 413 may move in the axial direction and contact the stopper 241, or may be separated from the stopper 241. As described below, the axial force for separating the moving member 413 from the stopper 241 or the axial force for contacting the moving member 413 to the stopper 241 may be generated by an electromagnet 242 or an elastic member 412.

Referring to FIG. 8, according to one embodiment, a friction surface may be formed on the opposing surfaces of the moving member 413 and the stopper 241. If the moving member 413 and the stopper 241 come into contact with each other, the moving member 413 is fixed in the rotational direction with respect to the stopper 241 by the friction of the friction surface, thereby restricting the rotation of the steering shaft 102.

Referring to FIG. 9, according to one embodiment, a gear or gear teeth may be formed on the opposing surfaces of the moving member 413 and the stopper 241. That is, the moving member 413 comes into contact with the stopper 241 and the gears teeth are engaged, thereby restricting the rotation of the steering shaft 102. As illustrated in the drawing, a face gear may be formed on the moving member 413 and the stopper 241.

The axial force for separating the moving member 413 from the stopper 241 or the axial force for contacting the moving member 413 to the stopper 241 can be generated by an electromagnet 242 or an elastic member 412.

According to one embodiment, the clutch unit 240 may include an electromagnet 242 that generates an attractive or repulsive force to the moving member 413. The controller 120 of the steer-by-wire type steering apparatus 100 according to the present embodiments may selectively limit the rotation of the steering shaft by controlling the power supplied to the electromagnet 242.

According to one embodiment, the moving member 413 may include a permanent magnet, and may contact and be restrained to the stopper 241 or separated from the stopper 241 by the attractive or repulsive force due to the interaction with the electromagnet 242.

According to one embodiment, the rotor 230 may further include an elastic member 412 provided between the fixed member 411 and the moving member 413. The moving member 413 may be selectively restrained to the stopper 241 by the attractive force or repulsive force provided by the electromagnet 242 and the elastic force provided by the elastic member 412. According to one embodiment, the elastic member 412 may be a plate spring whose two ends are connected to the fixed member 411 and the moving member 413.

According to one embodiment, the elastic member 412 provides the moving member 413 with an elastic force in the direction of being separated from the stopper 241. If the attractive force of the electromagnet 242 is generated, the moving member 413 may come into contact with the stopper 241.

That is, the moving member 413 may be formed of a magnetic metal such as steel, and when power is supplied to the electromagnet 242, the moving member 413 may be restrained to the stopper 241 by the magnetic force.

In a normal situation such as a driving state, power is not supplied to the electromagnet 242 and the moving member 413 is separated from the stopper 241 by the elastic force of the elastic member 412 (as shown in FIG. 6). Then, if power is supplied to the electromagnet 242, the moving member 413 is contacted and restrained to the stopper 241 by the magnetic force (as shown in FIG. 7).

According to one embodiment, the elastic member 412 provides the moving member 413 with an elastic force in the direction of contacting with the stopper 241. If the repulsive force of the electromagnet 242 is generated, the moving member 413 may be separated from the stopper 241.

That is, the moving member 413 may include a permanent magnet, and in a normal situation such as a driving state, power is supplied to the electromagnet 242 and the moving member 413 is separated from the stopper 241 by the repulsive force (as shown in FIG. 6).

Then, if the power to the electromagnet 242 is cut off, the moving member 413 comes into contact with the stopper 241 and is restrained by the elastic force of the elastic member 412 (as shown in FIG. 7).

According to the steering feedback actuator having a structure as described above and the steer-by-wire steering apparatus including the steering feedback actuator, it is possible to efficiently design the motor output and the size of the electrical components by separating a structure providing the steering reaction force and a structure limiting the steering angle.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The scope of protection of the present disclosure should be interpreted by the claims below, and all technical ideas within the scope equivalent thereto should be interpreted as being included in the scope of the present disclosure.

1. A steering feedback actuator comprising:
a housing to which a steering shaft is rotatably coupled;
a reaction motor coupled to the housing and connected to the steering shaft to provide a steering reaction force;
a rotor coupled to the steering shaft; and
a clutch unit including a stopper fixed to the housing, and optionally restraining the rotor to the stopper.

2. The steering feedback actuator of claim 1, wherein the clutch unit further comprises a case coupled to the housing.

3. The steering feedback actuator of claim 2, wherein the stopper is coupled to the case by being supported in a direction of rotation.

4. The steering feedback actuator of claim 3, wherein the stopper includes at least one support portion protruding in a radial direction, and the case includes a recessed groove into which the support portion is inserted.

5. The steering feedback actuator of claim 4, wherein the clutch unit further includes a damping member coupled to the support portion and positioned between the support portion and the recessed groove.

6. The steering feedback actuator of claim 1, wherein the rotor includes a fixed member fixed to the steering shaft, and a moving member connected to the fixed member and selectively restrained to the stopper by the clutch unit.

7. The steering feedback actuator of claim 6, wherein the stopper is provided coaxially with the steering shaft and opposite the moving member,
wherein the moving member is separated from the stopper by the clutch unit, or is restrained by contacting the stopper.

8. The steering feedback actuator of claim 7, wherein a friction surface is formed on the opposing surfaces of the moving member and the stopper.

9. The steering feedback actuator of claim 7, wherein gear teeth are formed on the opposing surfaces of the moving member and the stopper.

10. The steering feedback actuator of claim 7, wherein the clutch unit includes an electromagnet that generates an attractive force or a repulsive force on the moving member.

11. The steering feedback actuator of claim 10, wherein the rotor further includes an elastic member provided between the fixed member and the moving member.

12. The steering feedback actuator of claim 11, wherein the elastic member is a plate spring whose two ends are connected to the fixed member and the moving member.

13. The steering feedback actuator of claim 11, wherein the elastic member provides an elastic force to the moving member in a direction away from the stopper,
wherein the moving member comes into contact with the stopper if an attractive force of the electromagnet is generated.

14. The steering feedback actuator of claim 11, wherein the elastic member provides an elastic force to the moving member in a direction of contact with the stopper,
wherein the moving member is separated from the stopper and if a repulsive force of the electromagnet is generated.

15. A steer-by-wire steering apparatus comprising:
a steering feedback actuator including a housing to which a steering shaft is rotatably coupled, a reaction motor coupled to the housing and connected to the steering shaft to provide a steering reaction force, a rotor coupled to the steering shaft, and a clutch unit including a stopper fixed to the housing and optionally restraining the rotor to the stopper; and
a road wheel actuator that steers a wheel according to a rotation angle of the steering shaft.

16. The steer-by-wire steering apparatus of claim 15, further comprising a controller controlling the clutch unit.

17. The steer-by-wire steering apparatus of claim 16, wherein the steering feedback actuator further includes a steering angle sensor for detecting the rotation angle of the steering shaft.

18. The steer-by-wire steering apparatus of claim 17, wherein the controller controls the clutch unit so that the rotor is restrained by the stopper when a steering angle received from the steering angle sensor reaches a specific maximum steering angle.

19. The steer-by-wire steering apparatus of claim 16, wherein the road wheel actuator further includes a sliding bar having both ends connected to the wheel and sliding according to the rotation angle of the steering shaft, and a stroke sensor for detecting a stroke of the sliding bar.

20. The steer-by-wire steering apparatus of claim 19, wherein the controller controls the clutch unit so that the rotor is restrained by the stopper when the stroke received from the stroke sensor reaches a specific maximum stroke.
